(19) United States
(12) Patent Application Publication
(10) Pub. No.: US 2007/0212959 A1
(43) Pub. Date: Sep. 13, 2007

(54) Fused spacer fabric pads

(75) Inventor: Michael Johnson, El Paso, TX (US)

Correspondence Address: BANNER & WITCOFF, LTD., 1100 13th STREET, N.W., SUITE 1200, WASHINGTON, DC, 20005-4051, US

(73) Assignee: Mexican Technologies Company, Inc. (Texas Corp.), El Paso, TX (US)

(21) Appl. No.: 11/372,341

(22) Filed: Mar. 10, 2006

(51) Int. Cl. B32B 5/02

(52) U.S. Cl. 442/59; 442/149; 442/150; 442/43

(57) ABSTRACT

A fused spacer fabric pad is provided having an upper layer of fabric, a lower layer of fabric, a plurality of spacer fibers therebetween, and a bead along lateral edge portions of the pad. The bead acts as a fused joint between the upper and lower layers of fabric. A method for forming the spacer fabric pad can include compressing portions of the spacer fabric together to form an outline of the spacer fabric pad, melting the compressed portions to form a fused joint, and cooling the fused joint while compressing the portions. The method can be performed using a die press that has a first platen, an opposing second platen, and a fusing die attached to the first platen. The fusing die can include a fusing blade that substantially forms the outline of the spacer fabric pad and that is formed of an electrically resistive material.

### TECHNICAL FIELD

This invention relates generally to spacer fabric pads, such as air permeable spacer fabric pads that can be used with ventilated automotive chairs, and to apparatus and methods for forming the same.

### BACKGROUND

Spacer fabric is a type of padding made from an upper layer spaced apart from a lower layer by a plurality of spacer fibers. The spacer fibers include fibers that are generally vertically oriented when the spacer fabric is horizontal, which act as tiny support columns between the upper and lower layer. The spacer fibers have spring characteristics such that they bias the upper and lower layers apart from each other, but can bend to permit the layers to move toward each when the spacer fabric is compressed. The spacer fabric can be air-permeable to permit air to flow transversely through the fabric between the upper and lower layers. Conventional spacer fabric is used in automotive chairs, and may be air-permeable to provide ventilated automotive seat cushions.

The spacer fabric is cut to form pads for the seat portion of the automotive chair. The pads are sewingly connected to fastening features, upholstery fabric, and/or other portions of the automotive chairs. Conventional spacer fabric pads include marker notches along edge portions to aid with their assembly with a chair or other device. During assembly, the marker notches act as guides and alignment features for manufacturing personnel and/or assembly equipment.

FIG. 1 shows a conventional spacer fabric pad 10 for use with an automotive seat. Notches 14 are formed along the edges 12 of the pad as appropriate for use as guides to properly position and align the pad during assembly with other automotive seat components. FIGS. 2-5 show a portion 2 of pad 10 in further detail. As shown, the pad includes a top layer of fabric 16 spaced apart from a lower layer of fabric 18 by fibers 21. The fibers 21 form thin columns that extend between the fabric layers to bias the layers apart from each other. As shown in FIG. 3, the fibers can form air ducts in the spaces between the fibers, which permit air to flow transversely through the pad between the upper and lower layers. For example, air 28 blown toward lower layer 18 flows through ducts formed between the fibers and exits through ports 22 formed in the upper layer 16 as air jets 30.

As shown in FIG. 4, when upper layer 16 is compressed toward lower layer 18 against a rigid surface 40, the column fibers 21 bend. As they resist bending, the fibers laterally skew the upper layer with respect to the lower layer. As illustrated, a point X in the upper layer laterally shifts in direction 38 when the upper layer is pressed downward in direction 36 toward the lower layer, such as by a finger 36, due to the bending fibers. The lateral shifting of the layers during compression can adversely affect manufacture of the pads.

Conventional pads are cut from a larger sheet of spacer fabric while compressing the spacer fabric to force the upper and lower layers toward each other. Thus, while the upper and lower layers are laterally skewed with respect to each other as illustrated in FIG. 4, the conventional pads are cut and the notches 14 are formed therein. This results in the top portion 24 and the bottom portion 26 of each marker notch 14 being offset from each other when the pad is uncompressed (FIGS. 3 and 5). In addition, because many of the bent fibers are severed when cutting the pad, the free ends 32 of these cut fibers flare away from cut edge 12 or extend above the top or bottom layers.

FIGS. 6 and 7 show a conventional spacer fabric pad 10 installed in an automotive chair 50 below the top layer of upholstery 54 in its seat portion 52. Upholstery 54 includes vent holes 56 that permit ventilation air 28 blown through the spacer fabric to pass though it to the upholstery. The free ends 32 of cut fibers along the edges of the conventional spacer fabric pads can poke through the upholstery vent holes and make contact with the automotive occupant, which can be uncomfortable to the occupant. Automotive seats for which free ends 32 poke through the upholstery are typically disregarding during production as unacceptable seats, which results in production losses. In addition to creating production losses, the free ends 32 often become entangled with sewing equipment during assembly of the seats, which causes further production losses and slows production.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A fused spacer fabric pad is provided according to aspects and features of the invention, which generally includes an upper layer of fabric, a lower layer of fabric, a plurality of spacer fibers therebetween, and a bead along lateral edge portions of the pad. The bead acts as a fused joint between the upper and lower layers of fabric. A method for forming a spacer fabric pad according to the invention can include compressing portions of spacer fabric together to form an outline of the spacer fabric pad, melting the compressed portions to form a fused joint, and cooling the fused joint while compressing the portions.

The method can be performed using a die press that has a first platen, an opposing second platen, and a fusing die attached to the first platen. The fusing die can include a fusing blade that substantially forms the outline of the spacer fabric pad and that is formed of an electrically resistive material that generates heat when an electric current passes through it. These and other aspects and features of the invention will be described in greater detail below.

### BRIEF DESCRIPTION OF THE DRAWINGS

FIG. 1 is a top view of a conventional spacer fabric pad.

FIG. 2 is a top view of region 2 of the conventional spacer fabric pad of FIG. 1.

FIG. 3 is a sectional view along line 3-3 of FIG. 2.

FIG. 4 is another sectional view along line 3-3 of FIG. 2 illustrating the tendency of spacer fabric to skew laterally during compression.

FIG. 5 is perspective view of region 2 of the conventional spacer fabric pad of FIG. 1.

FIG. 6 is a cut away view of an automotive chair that includes the conventional spacer fabric pad of FIG. 1.

FIG. 7 is a top view of a seat portion of the automotive chair of FIG. 6.

FIG. 8 is a top view of a spacer fabric pad that illustrates aspects and features of the present invention.

FIG. 9 is sectional view along line 9-9 of FIG. 8.

FIG. 10 is a perspective view of the spacer fabric pad of FIG. 8.

FIG. 11 is a top view of portion 102 of FIG. 8.

FIG. 12 is a sectional view along line 12-12 of FIG. 11.

FIG. 13 illustrates a method for forming a spacer fabric pad according to aspects and features of the invention.

FIG. 14 shows a die press for use with forming spacer fabric pads according to aspects and features of the invention.

FIG. 15 shows a fusing die of the die press of FIG. 14.

FIG. 16 is a perspective view of region 306 of FIG. 15.

FIG. 17 is a partially cut away view of region 308 of FIG. 15.

### DETAILED DESCRIPTION OF THE DRAWINGS

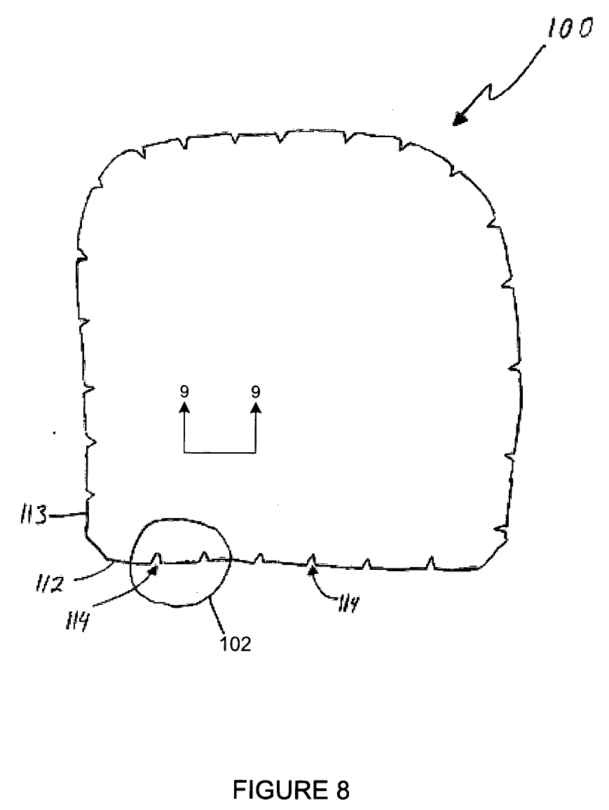

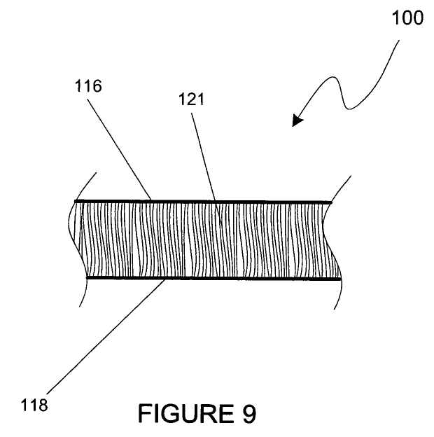

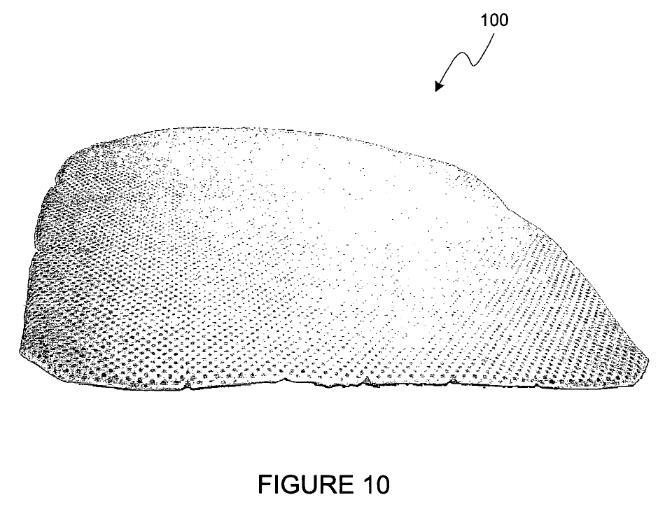

FIGS. 8-11 show an example spacer fabric pad 100 that illustrates various aspects and features of the invention. The spacer fabric pad 100 is only one example of a spacer fabric pad for illustrating various aspects and features of the invention. It is understood that other configurations of spacer fabric pads according to the invention may include only some of the aspects and features described herein in various combinations, along with other features. Spacer fabric pad 100 and its aspects and features are described herein in the general context of an automotive chair component. However, spacer fabric pad 100 and other configurations of spacer fabric pads according to the invention may be used with other devices and in a variety of environments.

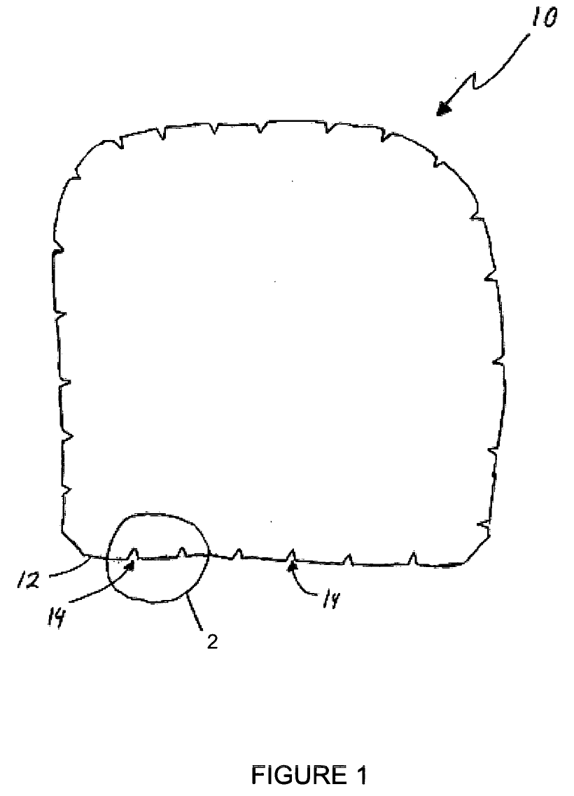

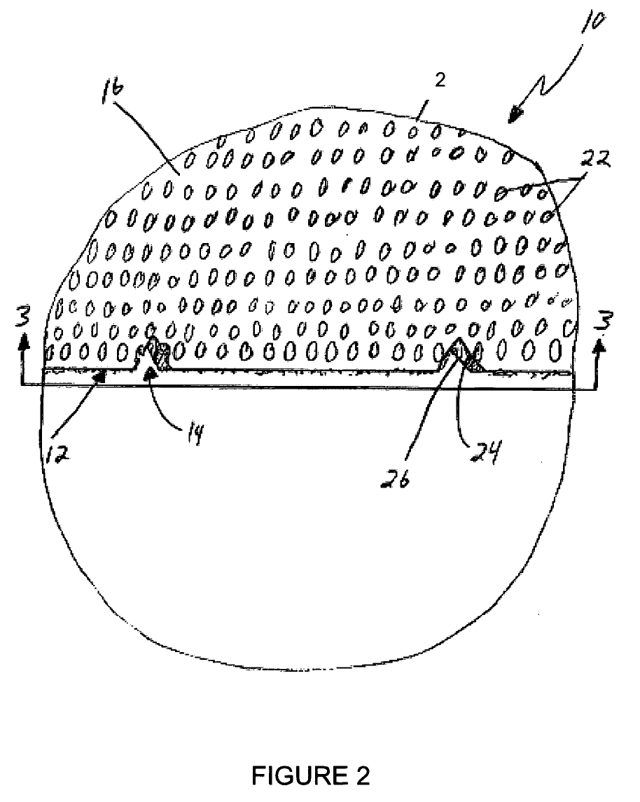

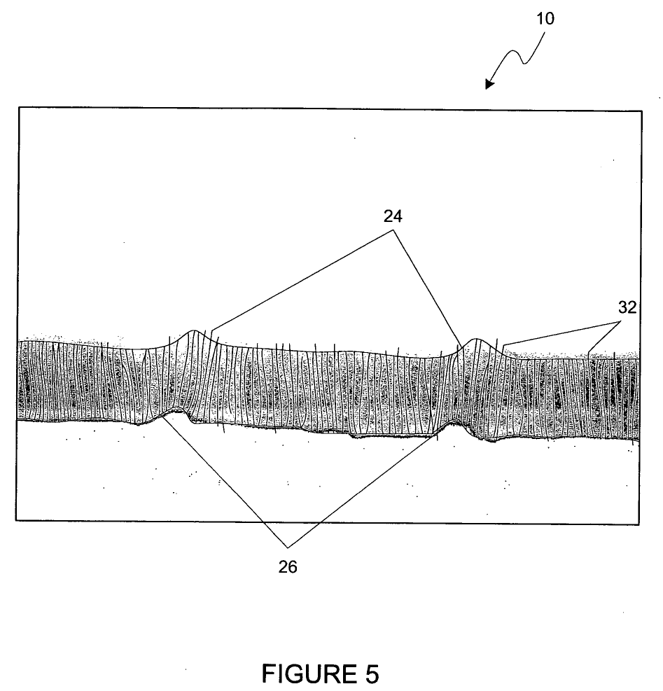

Spacer fabric pad 100 is generally the same as spacer fabric pad 10 described in FIGS. 1-7, except as discussed hereafter, as shown in FIGS. 8-12, and as described in the claims. Spacer fabric pad 100 generally includes an upper layer of fabric 116 spaced apart from a lower layer of fabric 118 by a plurality of spacer fibers 121 (FIG. 9). The fibers can include fibers that are generally vertically oriented when the spacer fabric is horizontal, which act as tiny support columns between the upper and lower layer. The fibers can also include fibers in other orientations and configurations (not shown), such as loops of fibers and mesh of fibers. The fibers act to bias the upper and lower fabric layers apart from each other in the absence of compressive forces on the pad while providing spring characteristics to permit compression of the spacer fabric pad.

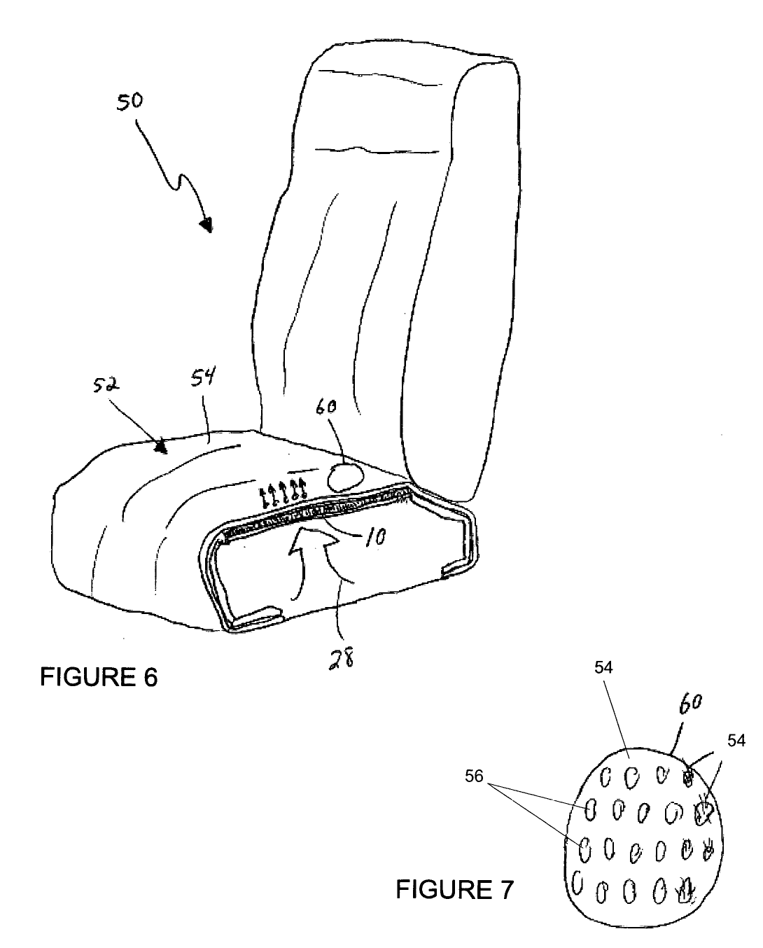

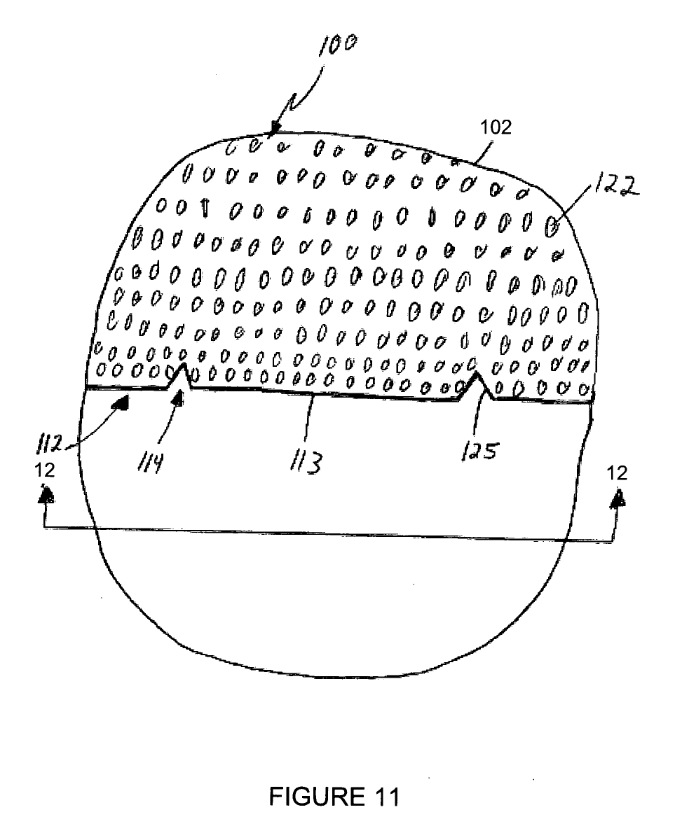

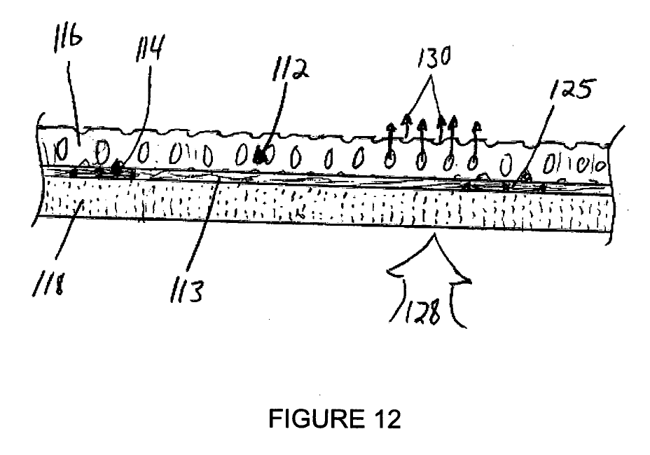

A generally vertical orientation of fibers 121 is preferred in some air-permeable configurations of the spacer fabric pad. For example, as discussed previously along with FIG. 6, spacer fabric pad 110 may be used in place of spacer fabric 10 as a component of a ventilated automotive chair. The general vertical orientation of the fibers form air ducts to channel air flowing through the lower layer 118, the fibers, and the upper layer 116 of the pad. As shown in FIGS. 11 and 12, the upper layer of fabric 116 can include ports 122 to enhance airflow 130 out of the spacer fabric pad 100. The lower layer of fabric 118 can be an air permeable fabric lacking large ports, such that it can act as a filter to prevent dust or other particles from being blown up through the seat to the occupant. In one configuration, the fibers 121 are polyester fibers that provide a resilient field of columnar spacer fibers. The upper and lower fabrics can also be made of polyester to provide an overall resilient and robust spacer fabric pad that performs as desired in a variety of environments (e.g., moist, dry, hot or cold environments) for extended periods of time. It is understood, however, that a variety of other materials and fabrics may be used for the fiber and the layers of fabrics.

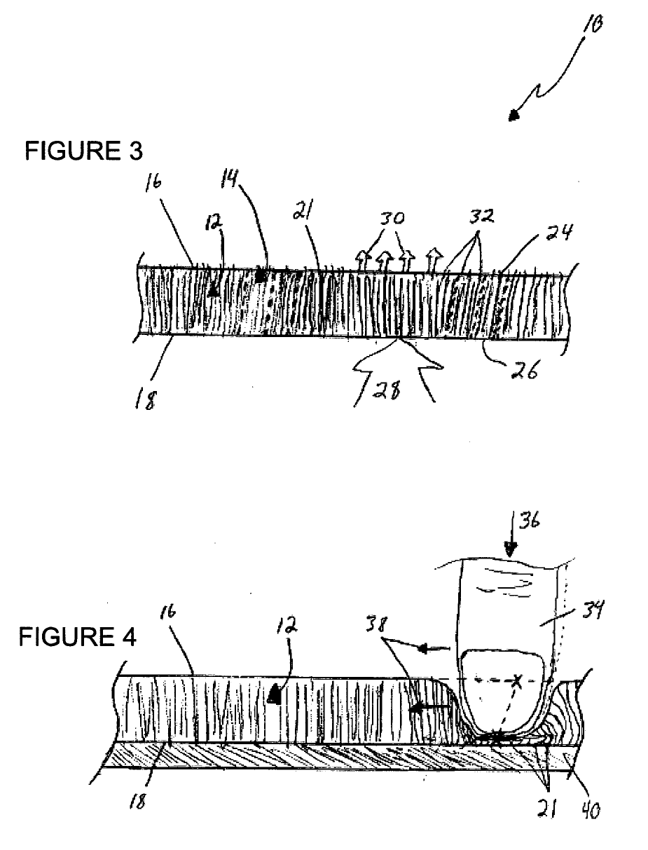

As shown in FIG. 11, spacer fabric pad 100 also includes marker notches 114 along its edge portions 112. The marker notches aid with assembly of the pad into a finished product. For example, in an automobile seat device, the marker notches can aid with aligning the pad for assembly with fastening features, upholstery fabric, and/or other portions of an automotive chair. The marker notches 114 are clearly formed and easily identifiable notches formed in a bead 113 along the edge portions 112 of the pad. In contrast with conventional spacer fabric pads, the marker notches 114 are not skewed like conventional marker notches 14 shown in FIGS. 3-5. Assembly is enhanced via the use of clearly formed and identified marker notches 114 at the appropriate location along the spacer fabric pad. Clearly formed and identifiable marker notches reduces manufacturing time during automotive chair assembly and eliminates waste and other losses resulting from misaligned or improperly assembled pads.

As shown in FIGS. 8-12 and as clearly illustrated in FIG. 12, the upper and lower layers of fabric are joined to one another along edge portions 112 to provide a fused spacer fabric pad. The layers of fabric join together to form a bead 113 around the periphery of the spacer fabric pad. Although shown as extending around the perimeter of the pad, bead 113 can extend around only a portion of the pad as desired. For many applications, however, it is preferable to completely fuse the perimeter of the pad.

Fusing the spacer fabric pad 100 and the use of fusing bead 113 can provide several advantages for the production, use and assembly and spacer fabric pads, as well as for the end products with which they are used. For example, fusing bead 113 generally seals fibers 121 along the edge portions of the pad within the pad itself, which reduces the likelihood of creating broken or cut fibers and retains any such broken or cut fibers within the pad. Thus, there is little likelihood that fibers will extend from the spacer fabric pad through an automobile seat to make contact with an occupant, or that fibers will interfere with sewing or other assembly equipment. In addition, as noted above, fusing bead 113 provides clearly formed and identifiable marker notches 114 that do not include misaligned/skewed portions, which can improve assembly of the pads with other components and can reduce losses due to improperly assembled pads.

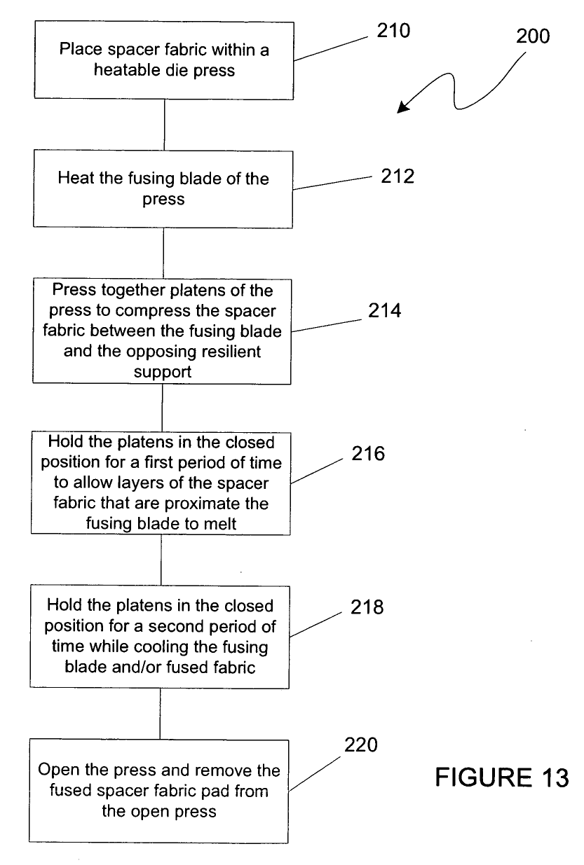

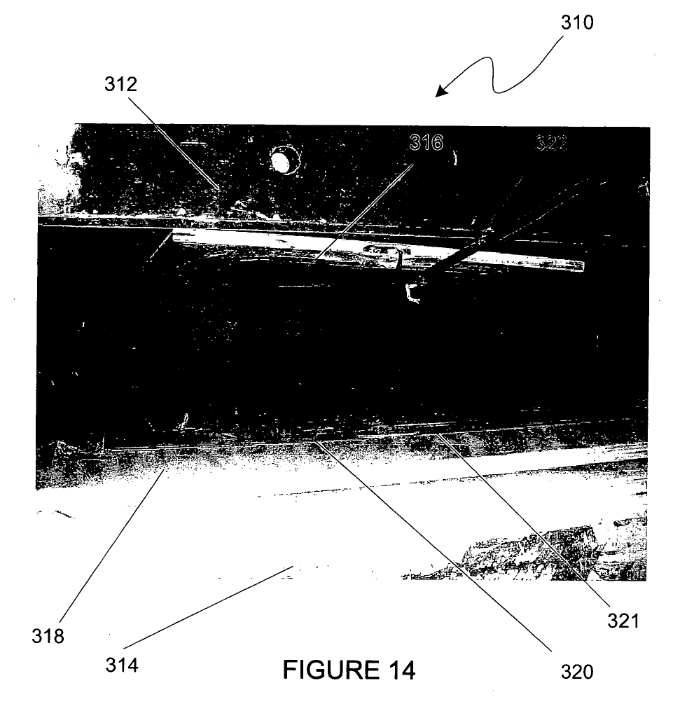

FIG. 13 generally illustrates a method 200 for forming a fused spacer fabric pad, such as spacer fabric pad 100, according to aspects of the present invention. The example method 200 can be practiced with the example devices shown in FIGS. 14-17, which also illustrate features of the invention. In general, the fused spacer fabric pad is formed via a die having a heated fusing blade, which simultaneously cuts the spacer fabric pad from the spacer fabric material and fuses the upper and lower layers of fabric to each other. Method 200 is discussed in more detail following the discussion of the devices shown in FIGS. 14-17.

FIG. 14 shows an example heatable die press 310 for forming spacer fabric pads from a larger sheet of spacer fabric. The press includes a movable upper platen 312, a lower platen 314, a heatable die 316, a lower dieboard 318, resilient support 320, and, optionally, a cover material 321. The heatable die 316 is attached to the upper platen, which is vertically movable toward and away from the lower platen. The heatable die includes a power source 322 for heating its fusing blade during manufacturing operations.

The lower dieboard is attached to the lower platen and includes a resilient support 320 on its upper portion. Resilient support 320 retains the spacer fabric during manufacture while providing an upward bias against the spacer fabric. The upward bias of the resilient support helps to keep the spacer fabric pressed against the upper platen and in good contact with the heatable die during formation of the fusing bead around the spacer fabric pad. Resilient support 320 can be made from a heat resistant foam material, such as a heat resistant type of polyurethane foam. A cover material 321 can be placed on top of the resilient support along the perimeter of the spacer fabric pad to protect the resilient support from the heat of the heatable die and to reduce the likelihood of the spacer fabric sticking to the resilient support. For instance, fabric sheets or tape material could be placed on the resilient support at the regions where the perimeter of the spacer fabric pad will be formed. The cover material could be made from a fiberglass or nylon fabric that is coated with a non-stick coating, such as the coating known as TEFLON.

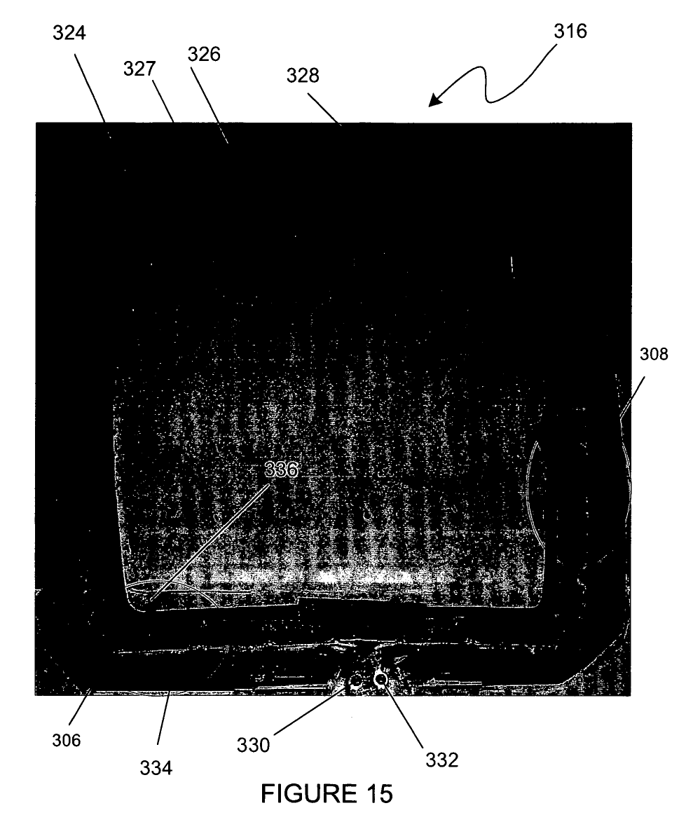

As shown in FIGS. 15-17, the heatable die 316 generally includes a platen backing 324, a die backing 326, a blade guide 327, a fusing blade 328 and electrical connectors 330 and 332. Optionally, the heatable die can include a blade cover 334 and insulating materials 336 and 342. Platen backing 324 provides a base for the die to attach to the upper platen. Platen backing 324 can be made out of wood, metal, or other suitable materials for use with die presses. Preferably, however, platen backing 324 is made from a material having low electrical conductivity, such as wood, to isolate the electrical current running through the fusing blade from the rest of the die and to prevent accidental electrical shock. Die backing 326 provides a base for the fusing blade, which preferably is made from a rigid material having low electrical conductivity and high heat resistance, such as a phenolic resin.

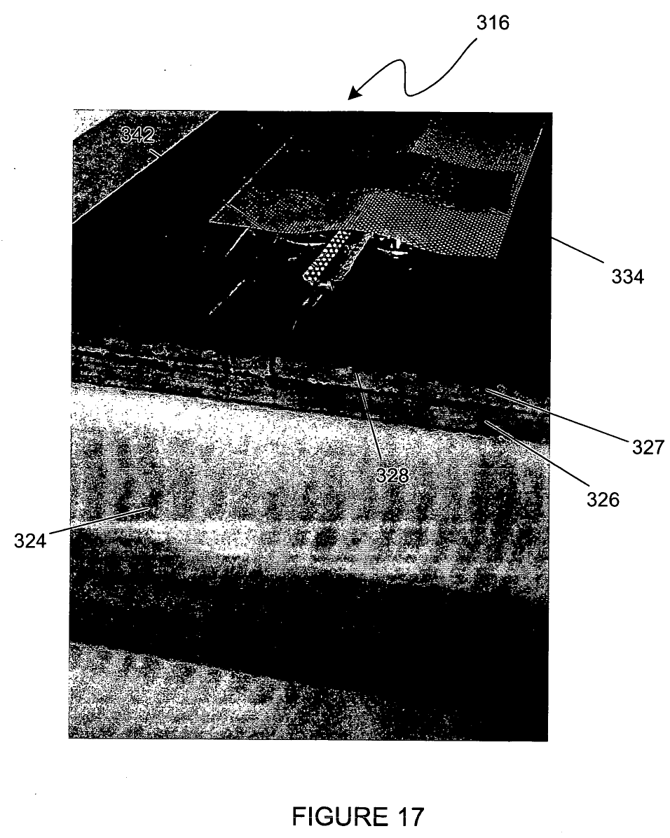

Blade guide 327 attaches to the die backing and provides support for the fusing blade. A slot 340 (FIG. 17) formed in the blade guide retains the fusing blade in its desired configuration, while permitting it to expand longitudinally within the slot when it becomes heated. The blade guide is preferably made from a material having low electrical conductivity that is also heat resistant. In one configuration, the material known as KEVLAR is used to form the blade guide, due to its high heat resistance properties. Insulating material 336, such as a woven fiberglass or nylon textile, can also be used to further insulate the platen backing 324 from heat or electrical current. Additional insulating material 342 can optionally be wrapped around the portion of the fusing blade located in slot 340 (FIG. 17) to insulate the blade guide 327 and die backing 326 from the heat and electrical current of the fusing blade.

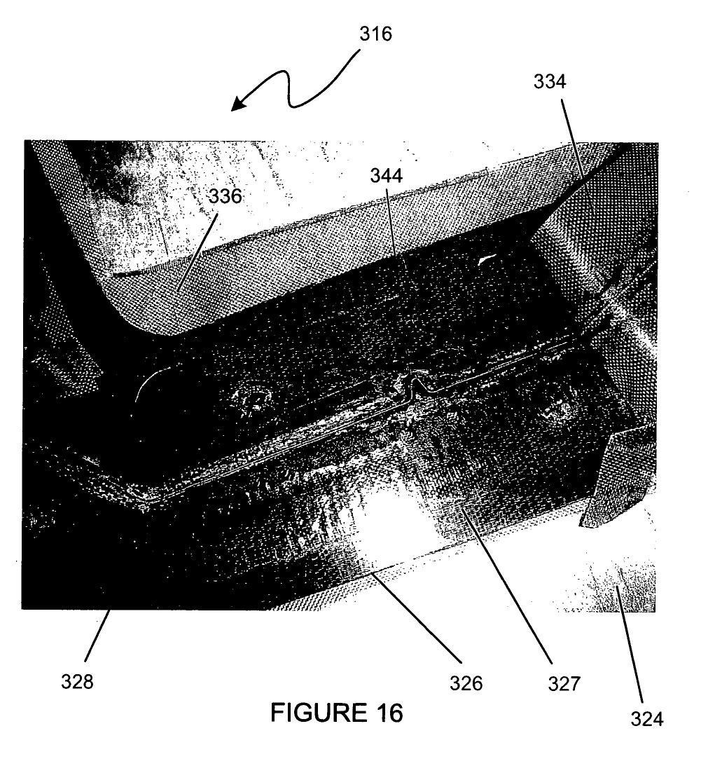

The fusing blade 328 connects to the blade guide, is retained within slot 340 of the blade guide, and a portion of it extends above the blade guide for making contact with the spacer fabric during fusing operations. The fusing blade outlines the desired perimeter of the spacer fabric pad to be formed by the die. In addition, the fusing blade includes U-shaped or V-shaped bends 344 (FIG. 16) for forming the marker notches 114 (FIG. 11) in the spacer fabric pad. Bends 344 formed in the fusing blade permits the spacer fabric pad to be simultaneously cut from the spacer fabric and formed along with its marker notches via a single operation. In addition, the use of bends 344 provides expansion relief to the fusing blade to accommodate thermal expansion of the heated blade. When the blade is heated and expands, bends 344 help to accommodate the expansion by forming relatively sharp turns. As the blade cools, which according to method 200 discussed below can occur during contact with the spacer fabric at the end of the fusing operation, the bends open up. Opening up of the bends near the end of the fusing operation can help to further delineate the marker notches 114 (FIG. 11) by opening them up further while the bead 113 is still warm.

Fusing blade is preferably made from a material having a relatively high electrical resistivity, such that it heats up rapidly when an electrical current runs through it. For example, the fusing blade can be made from the metal known as NICHROME, which is a non-magnetic alloy of nickel and chromium. NICHROME may be desirable for its corrosion resistant properties, its relatively high melting point (about 1400 degrees Celsius), its relatively high resistivity and its resistance to oxidation at high temperatures.

Electrical connectors 330 and 332 connect with a power source 322 to provide an electrical current through the fusing blade. In one configuration, a voltage of about 24 volts is applied to a NICHROME fusing blade to provide sufficient heat for a fusing operation. A blade cover 334 can also be used to cover the fusing blade during operation to reduce the likelihood of the fused spacer fabric sticking to the blade. In one configuration, blade cover 334 is formed from a heat and electrically resistant fabric, such as a fiberglass or nylon fabric, which is coated with a non-stick coating, such as the coating known as TEFLON.

Referring now to FIG. 13, example method 200 for forming a spacer fabric pad is generally illustrated, which can be performed using the devices of FIGS. 14-17. As shown, step 210 includes placing the spacer fabric within a heatable die press and step 212 includes heating the fusing blade of the press. In one configuration, the fusing blade is heated prior to making contact with the spacer fabric to ensure the blade is adequately heated, as the spacer fabric acts as a heat sink while its upper and lower layers melt and fuse together, which draws heat from the blade. However, the fusing blade can be heated while in contact with the spacer fabric if sufficient electricity is provided to the blade during contact. Step 214 includes pressing the platens together in a closed position to compress portions of the spacer fabric between the blade and the resilient support of the opposing platen. In the closed position, the heated fusing blade melts upper and lower fabric layers 116 and 118 and fibers 121 between the layers (FIG. 9) that are compressed between the fusing blade and the opposing board. Fabric layers and fibers proximate the fusing blade may also be melted depending on the type of fabrics (e.g., their melting points), the temperature of the fusing blade, and other properties (e.g., the thermal conductivity of the blade and the length of time the blade is heated while in the closed position). The method further includes the step 216 of holding the platens in the closed position for a first period of time to allow sufficient melting to occur and the step 218 of holding the platens in the closed position for a second period of time while cooling the fusing blade and/or the fused fabric.

Heat may or may not be provided to the fusing blade during the first time period, depending on the thermal energy required to sufficiently melt portions of the spacer fabric. For example, the fusing blade may simply be heated prior to closing the platens and heating may be discontinued just before or as the platens are closing. Thus, the first period may simply be the time it takes for the fusing blade to compress portions of the spacer fabric as the platens are closing. In other configurations, heat may be applied prior to closing the platens, while they are closing, and/or for a period of time in the closed position. For instance, power may not be applied to the fusing blade in some configurations until the platens are in the closed position.

Step 218 permits the melted portions of the spacer fabric to cool in the fused configuration, which permits bead 113 shown in FIG. 12 to partially or fully solidify prior to opening the platens. The second period of time may be relatively long, such as 30 seconds to a minute, or relatively short, such as one or more seconds, depending on material properties of the spacer fabric and other parameters, such as the amount of heat applied. If necessary, the fusing blade, the die, and/or the spacer fabric can be rapidly cooled to accelerate setting of the fused bead. For example, cool air could be blown through the closed platens prior to opening the press. Step 220 includes opening the press and removing the fused spacer fabric pad from the center portion of the open press, as well as the scrap spacer fabric material around the edge portions. Once removed, spacer fabric pad 100 can be stored for shipping or for other operations, such as assembly with automotive seat components.

Using one or more of the features, devices and methods described above, improved spacer fabric pads can be provided. Although the description above provides illustrative examples and methods, it should be understood that the various examples and sequences may be rearranged, divided, combined and subcombined as desired. Accordingly, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim the following:

1. A fused spacer fabric pad having a top, a bottom and lateral edge portions, the pad comprising:
an upper layer of fabric at the top portion;
a lower layer of fabric at the bottom portion;
a plurality of fibers extending between the upper and lower layers of fabric, the fibers biasing the upper layer apart from the lower layer; and
a bead along the lateral edge portions, the bead joining the upper and lower layers of fabric.

2. The fused spacer fabric pad of claim 1, wherein the bead forms marker notches along the lateral edge portions of the pad.

3. The fused spacer fabric pad of claim 1, wherein the bead includes melted portions of the upper layer of fabric fused with melted portions of the lower layer of fabric.

4. The fused spacer fabric pad of claim 1, wherein the fibers include columnar fibers vertically extending from the lower layer to the upper layer.

5. The fused spacer fabric pad of claim 1, wherein the fibers form a mesh of fibers.

6. A method for forming a fused spacer fabric pad having a lower layer of fabric biased apart from an upper layer of fabric via a plurality of fibers disposed therebetween, the method comprising:
compressing portions of spacer fabric together to form an outline of a spacer fabric pad;
while compressing the portions of spacer fabric together, melting the compressed portions of spacer fabric to form a fused joint; and
while compressing the portions of spacer fabric together, cooling the fused joint.

7. The method of claim 6, wherein, for the step of compressing portions of spacer fabric together, the outline includes a plurality of bends to form marker notches on the fused spacer fabric pad.

8. The method of claim 6, wherein the step of compressing portions of spacer fabric together includes placing the spacer fabric between two platens of a die press having a fusing die on one of the platens, and moving the platens toward each other until portions of the spacer fabric are compressed.

9. The method of claim 8, wherein the step of melting compressed portions of the spacer fabric includes providing a heated fusing blade along the outline of the spacer fabric pad.

10. The method of claim 9, wherein the step of providing the heated fusing blade includes heating the fusing blade by passing an electric current through the fusing blade.

11. The method of claim 9, wherein the step of providing the heated fusing blade includes heating the fusing blade prior to compressing the portions of the spacer fabric together.

12. The method of claim 9, wherein the step of providing the heated fusing blade includes heating the fusing blade while compressing the portions of the spacer fabric together.

13. The method of claim 9, wherein the step of compressing portions of spacer fabric together includes biasing the spacer fabric toward the heated fusing blade.

14. A die press for forming fused spacer fabric pads, the die press comprising:
a first platen;
a second platen opposing the first platen;
a fusing die attached to the first platen, the fusing die comprising:
a base; and
a fusing blade attached to the base, the fusing blade substantially forming the outline of a spacer fabric pad, the fusing blade formed of an electrically resistive metal, the electrically resistive metal generating heat when an electric current passes through it; and
a power source electrically connected to the fusing blade for passing a current through the fusing blade.

15. The die press of claim 14, wherein the fusing blade includes marker notch bends for forming marker notches at peripheral portions of the spacer fabric pads.

16. The die press of claim 14, wherein the fusing blade is formed from a metal known as NICHROM.

17. The die press of claim 14, wherein the base includes a blade guide for retaining and supporting the fusing blade, the blade guide forming a slot along the outline of the spacer fabric pad, the slot receiving a base portion of the fusing blade therein, an opposite fusing portion of the fusing blade extending from the slot toward the opposing second platen.

18. The die press of claim 17, wherein the blade guide is formed of a heat resistant material having a melting point above the melting point of the materials in the fused spacer fabric pads.

19. The die press of claim 18, wherein the heat resistant material includes the material known as KEVLAR.

20. The die press of claim 17, wherein the base further includes a die backing disposed between the blade guide and the first platen, the die backing formed of an electrically resistive and heat resistant material.

21. The die press of claim 19, wherein the electrically resistive and heat resistant material is formed from a phenolic resin.

22. The die press of claim 14, wherein the second platen opposing the first platen includes a resilient support for biasing spacer fabric placed thereon toward the first platen.
